(19) United States
(12) Patent Application Publication
(10) Pub. No.: US 2013/0328650 A1
(43) Pub. Date: Dec. 12, 2013

(54) DIVERGENT FLUX PATH MAGNETIC ACTUATOR AND DEVICES INCORPORATING THE SAME

(71) Applicant: Glen A Robertson, Madison, AL (US)

(72) Inventor: Glen A Robertson, Madison, AL (US)

(21) Appl. No.: 13/489,682

(22) Filed: Jun. 6, 2012

(51) Int. Cl. H01F 7/08

(52) U.S. Cl. CPC H01F 7/08
USPC 335/234

(57) ABSTRACT

An energy efficient magnetic actuator includes an armature with attached shaft and a divergent flux path electromagnet with an outer magnetic enclosure containing a ring or toroid permanent magnet, two control coils one on either side of the permanent magnet, and a center pole piece through the permanent magnet and control coils having a bore to allow movement of the shaft. The majority of the magnetic flux in the center pole piece can be diverted in a single direction by a pair of control coils for the purpose of moving and magnetically latching the armature to the electromagnet or de-latching the armature from the electromagnet with aid of external forces to the shaft to overcome the small residual magnetic latching force resulting from leakage flux. The control coils may be energized in a variety of ways to achieved desirable linear or bi-linear motion of the armature.

### FIELD OF THE INVENTION

The present invention provides a multipurpose divergent flux path magnetic actuator containing a divergent flux path electromagnet wherein the magnetic flux from a toroid or ring shaped radially poled permanent magnet with extended and bi-directional coaxial poles is directionally induced to divert its paths by control coils placed about the center pole in order to magnetically attract an armature to one side of the magnetic actuator for the purpose of producing mechanical force on attached devices through a shaft firmly fixed to the armature.

The present invention provides a functional improvement over the design of patent application Ser. No. 12/987,344, by
Having one fixed attractor, allowing for a more direct replacement of conventional electromagnet type magnetic actuators, and
Providing a low energy magnetic actuator with ease of attachment.

Such a divergent flux path magnetic actuator may take on a variety of configurations facilitating use of such components in a variety of applications including applications involving the production of linear and linear reciprocating motion. Several novel electromagnetic devices of actuator constructions, which operate by diverting the path of magnetic flux from a radial poled permanent magnet, are described, such actuator constructions having increased efficiency and more desirable characteristics to include increased electrical efficiency as compared to prior art, specifically those using conventional magnetic actuators of similar function.

### BACKGROUND OF THE INVENTION

Magnetic force of attraction from an electromagnet is commonly used in a variety of magnetic actuators. In the field of such magnetic actuators, there is a continuous pursuit of increased electrical efficiency and reduced copper in the control coils. Accordingly, the present invention provides a magnetic actuator requiring less electrical energy with reduced copper in the control coils through the inclusion of a divergent flux path electromagnet, wherein the magnetic flux from a radially poled permanent magnet with extended coaxial poles is diverted by a pair of control coils, one placed on either side of the permanent magnet, to form a more energy efficient magnetic actuator. The present invention provides a functional improvement over:
The electromagnetic device of patent application Ser. No. 12/987,344 by combining one of the attractor plates with the housing to form a more conventional functioning magnetic actuator for easier replacement, and
The design of other latching magnetic actuators, where the addition of the latching components drive the device to be larger or heavier than prior art.
   The present invention can be designed to replace many conventional magnetic actuators used in prior art, specifically magnetic actuators using an armature with attached shaft and electromagnet similar to U.S. Pat. No. 2,934,090, 3,368,791, and other similar devices.

### SUMMARY OF THE INVENTION

It is an object of the present invention to provide an economical, pollution-free divergent flux path electromagnet than prior art, which may be used for a wide variety of linear and reciprocating movement applications.

It is another object of the invention to provide a divergent flux path electromagnet utilizing permanent magnets for producing mechanical force with reduced electrical input energy than prior art.

It is another object of the present invention to provide a divergent flux path electromagnet requiring less copper in the control coils than prior art.

It is another object of the invention to provide a divergent flux path electromagnet with reduced thermal heat emission than prior art.

It is another object of this invention to provide a divergent flux path electromagnet of design which can be manufactured and assembled in an easily accomplished, economic manner.

It is another object of the present invention to provide magnetic actuator containing a divergent flux path electromagnet.

It is another objective of the invention to provide a magnetic actuator which can be designed to replace conventional electromagnet magnetic actuators using an armature with attached shaft, and having similar functionality to U.S. Pat. No. 2,934,090, 3,368,791 and other similar devices.

These and other objects and advantages of the invention will become more apparent from the following description and the accompanying drawings.

A energy efficient magnetic actuator is provided containing an armature with attached shaft and a divergent flux path electromagnet to magnetically attract the armature and having a bore to allow movement of the shaft. The divergent flux path electromagnet, in the preferred embodiment, comprises a cylindrical can shaped magnetic enclosure with a closed end perpendicular to the cylindrical length and a cylindrical outer part or cylindrical pole parallel to the cylindrical length firmly attached and protruding from the closed end, and contains:
a. A toroid or ring shaped radially poled permanent magnet having concentric magnet pole faces,
b. A pair of control coils wound adjacent and on either side of the radially poled permanent magnet controlled by an external circuit means, and
c. A cylindrical shaped magnetic center pole through the control coils and permanent magnet with a bore to allow movement of the shaft attached to the armature.

In the preferred form of the invention:
1. The cylindrical pole, center pole, closed end and armature, regardless of the shape or size, the preferably formed of soft iron, steel or some other magnetic material, with the preferred material being one which provides low reluctance, exhibits low hysteresis, and has a high magnetic flux density capability; likewise could be of laminate type construction.
2. The center pole forms a bi-directionally magnetic flux path from the inner pole of the radially poled permanent magnet to both the closed end of the magnetic enclosure and the armature, bi-directionally through the cylindrical pole, and back to the outer pole of the radially poled permanent magnet. The center pole and the cylindrical pole comprise coaxial poles with the armature placed adjacent to the coaxial poles on one side and the closed end on the other.
3. Firmly attached to the armature is a non-magnetic shaft centered and extending centered through the center pole and the closed end for carrying out one or more desired functions. Insertion of the non-magnetic shaft through the center of the center pole forms the center pole piece into a cylinder to insure that the magnetic flux will reverse versa moving toward the center of the center pole when the control coils are activated.
4. The total magnetic flux from the permanent magnet should be enough to over saturate the flux path in one given direction of the center pole to insure there is enough magnetic force to latch the armature under the targeted force on the shaft. This is due to unavoidable leakage flux back toward the closed end. Making each flux path in the coaxial poles of different volume or magnetic permeability material can help improve the overall design; specifically by choosing less magnet resistive material in the magnetic flux path of the armature and higher resistive material in the magnetic flux path of the closed end.
5. Clearance or restriction of the armature and shaft movement is provided to insure an air gap will exists between the armature and the coaxial poles when enough force is applied to the end of the shaft protruding through the closed end over the design air gap. When no air gap exists between the armature and the coaxial poles and no force is applied to the shaft.
a. The magnetic flux from the permanent magnet is concentrated bi-directionally through the coaxial poles, and
through the closed end and the armature with enough magnetic flux to cause the armature to remain magnetically latched to the coaxial poles, and
b. The application of power to the controls will not unlatch the armature from the coaxial poles.
6. The control coil pairs are wired to give the same directional magnetic flux through the coaxial poles when energized as is done for the single coil in conventional electromagnets. This can be done for both series and parallel wired control coils; series connection is preferred to keep the applied voltage down. To insure high energy efficiency and prevent thermal heat emissions, the applied voltage/current to the control coils is pulsed. Short pulses only long enough to reverse the magnetic flux in the coaxial poles is needed. Pulsing allows for the use of smaller copper wire with smaller overall stack height in the control coils than would normally be designed for conventional electromagnets, i.e., milli-second pulsed currents in copper wire rated at 1 amp can be, in some cases, 10 Amp or higher without any damage to the wire. For example, increasing the amps by a factor of 10 reduces the number of turns needed to create a given magnetic flux in the coaxial poles by a factor of 10, which reduces the amount of copper needed in the control coils. Caution should be taken to not continuous apply current, as it is not necessary. Doing so could produce heat emission, which if high enough will demagnetize the permanent magnet, damage the wire's insulation or destroy the wire.
7. A circuit means is connected to the control coils pairs, which can be energized alternately in a pulsed timed sequential manner to produce linear or bi-linear magnetic force between the armature and the electromagnet to form a magnetic actuator with reduced electrical input energy. Single directionality of the armature is accomplished by pulsing the control coil pair for a brief defined time, diverting the permanent magnet's magnetic flux through the coaxial poles as defined by the direction of the magnetic flux produced by the control coils; reversing the current directions in sequence produces the opposite effect. For a given force, wire size, and number of coil turns, the pulsing time required to detach or attract the armature across the gap has been shown to decrease with increasing applied voltage. It has also been shown that increasing the voltage also allows for increased air gap distances. This allows for the development of divergent flux path electromagnets and magnetic actuators having variable reaction times and air gap with applied voltage.

The circuit means for the invention:
1. Pulse-switched H-bridge circuits provide a circuit means that can be used to activate or discharge the voltage/current from a properly sized and charged capacitor to pulse the control coils, but other circuit means are possible. H-bridges are uniquely suited as they are routinely used to switch/reverse the voltage/current to motors and can be produced from a variety of low cost integrated circuit technologies.
2. If the capacitor charging circuit is not isolated from the capacitor during discharge, the capacitor charging circuit should be designed to have a minimal charging current, typically with a charging current of about 10% or less of the expected impulse current, unless a faster repetition rate is needed. Low charging current is needed to prevent excesses current (power) to the control coils during the activation of the circuit means. A low charging current will also protect the control coils should an open circuit failure occur in the circuit means.
3. For fail safe conditions, a secondary capacitor can be on standby for discharge by a secondary circuit means to latch or unlatch the armature. Due to the variable reaction times with applied voltage, the secondary capacitor can be charged to a higher voltage for faster response.
4. Caution should be taken to use the proper integrated circuit technologies and protection circuitry to prevent damage to the integrated circuitry during pulsing. Shorts in the wiring can cause high back emf-voltages that can destroy integrated circuits and even short-burst of high voltage/current can overpower improperly selected integrated circuit.

### BRIEF DESCRIPTION OF THE DRAWINGS

For a better understanding of the present invention, reference may be made to the accompanying drawings in which:

FIG. 1 is a perspective view of one embodiment of the present invention;

FIGS. 2-3 are cross-sectional views of one embodiment of the present invention showing the different positions and showing the bi-directional magnetic flux paths;

FIGS. 4-5 show the preferred parallel connection of the control coils in the present invention.

FIG. 6 shows one of many H-bridge designs that are uniquely capable for energizing the control coils in the present invention.

FIG. 7 shows one simple method of charging a capacitor to voltages greater than 9V, providing the electrical energy source for discharged through the H-bridge of FIG. 6.

FIGS. 8-10 are current traces. FIG. 8 illustrates the current trace for conventional magnetic actuators. FIGS. 9-10 are current traces from two different versions of the present invention using the same capacitor/voltage setup and the method of FIGS. 4-7, where FIG. 9 shows an ideal current trace for minimum energy use and FIG. 10 shows that the capacitor/voltage setup was over designed for the versions of the present invention used.

FIGS. 11-12 show two of the present inventions of FIG. 2-3 back to back to increase the actuation length.

FIGS. 13-14 are cross-sectional views of FIGS. 2-3 showing one method of the present invention for use in a valve.

### DETAILED DESCRIPTION OF THE INVENTION

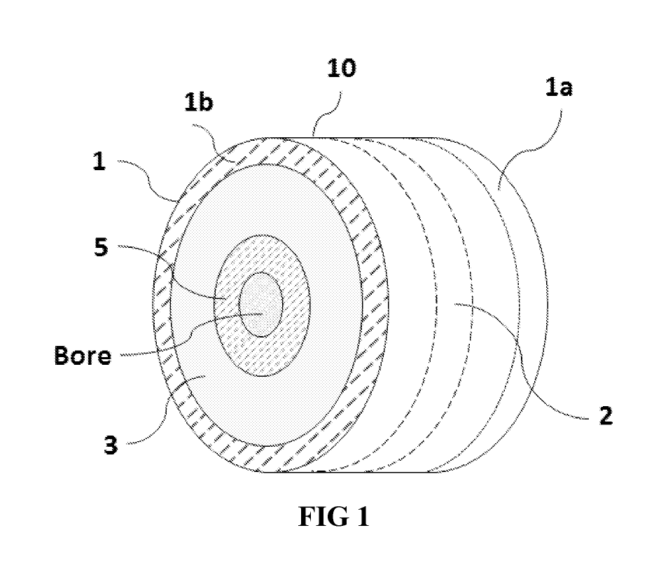

Referring now to the drawings, FIGS. 1-3 are provided to facilitate an understanding of the various aspects or features of the divergent flux path electromagnet technology utilized in the present invention. It is understood that multiple magnetic strength, shape and size divergent flux path electromagnets 10 are attainable using different magnetic strength, shape and size radial poled permanent magnets 2 with design suited for the present invention. The radial poled permanent magnet 2 may be composed of any desirable permanent magnet material and may include radial extensions to the poles 1 and 5 using magnetic materials giving the desirable magnetic field and force characteristics needed for a given application. Multiple shapes and sizes of the radial poled permanent magnet 2 are attainable using different shape and size permanent magnets as toroid, square, rectangle or other geometric shapes that can be either one piece or composed of multiple pieces. Regardless of the shape and size radial poled permanent magnet 2, the radial poling direction of the permanent magnet is perpendicular to the cylindrical length, which can be either: north outward—south inward or south outward—north inward from a defined center of the permanent magnet. Poling parallel to the cylindrical length will not produce the desired results. The preferred poling direction as used throughout this specification is north inward as it produces the highest magnetic force.

FIGS. 1-3 depict the preferred cylindrical form of the invention as used throughout this specification. In FIGS. 1-3, the permanent magnet 2 has a flat toroid shape and is poled radially with the north pole inward toward the center pole piece 5, allowing for a divergent flux path electromagnet 10 that is more functional in design over patent application Ser. No. 12/987,344, specifically toward a more direct and functional replacement of electromagnets in magnetic actuators with designs using an armature 6 with attached shaft 7 similar to U.S. Pat. No. 2,934,090, 3,368,791, and other similar devices.

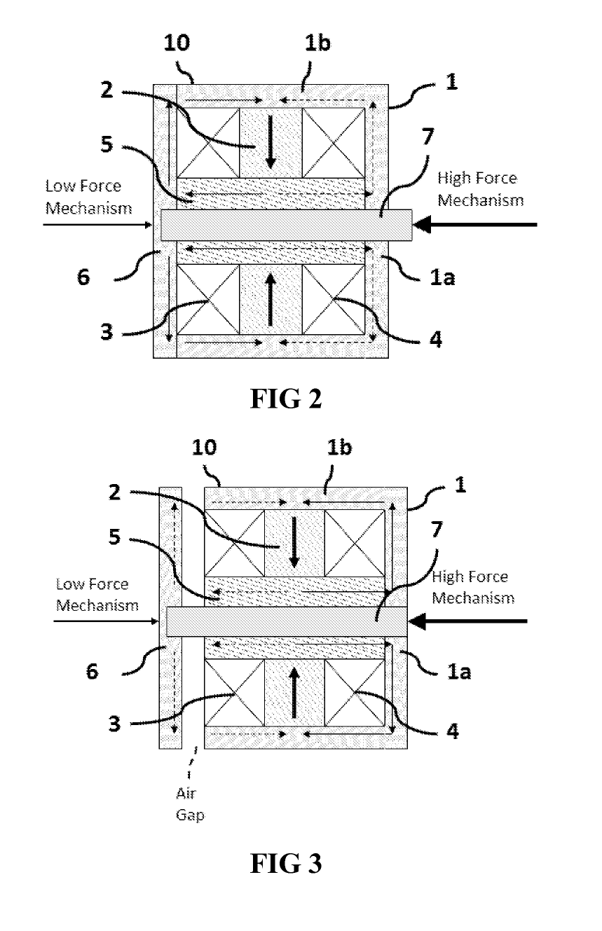

FIG. 1 depicts the preferred form of the divergent flux path electromagnet 10 and FIGS. 2-3 depict the magnetic actuator composed of the divergent flux path electromagnet 10 and the armature 6 with attached shaft 7. In FIGS. 1-3, the divergent flux path electromagnet 10 has a cylindrical can shaped magnetic enclosure or housing 1 with a firmly attached closed end 1a perpendicular to the cylindrical length and a cylindrical outer part or cylindrical pole piece 1b parallel to the cylindrical length firmly attached and protruding from the closed end 1a, and contains:
(a) A firmly fixed toroid or ring shaped radially poled permanent magnet 2 having concentric magnet pole faces,
(b) A firmly fixed pair of control coils 3 and 4 wound adjacent and on either side of the radially poled permanent magnet 2, wired to form a single solenoid like control coil with the same directional magnetic flux when energized,
(c) A cylindrical shaped magnetic center pole piece 5 through both the control coils 3 and 4 and the permanent magnet 2 firmly fixed with respect to the magnetic enclosure 1, where the center pole piece 5 and the cylindrical pole piece b form coaxial poles, and
(d) A bore extending centered through the center pole piece 5 and the closed end 1a of the magnetic enclosure 1 to accommodate a non-magnetic and moveable shaft 7.

In FIG. 1, shows a prospective view of the bore in the center pole piece 5 and the small dash line represent the inner side of the closed end 1a to give a prospective view of the thickness of the closed end 1a and the two larger dash lines represent the permanent magnet footprint inside the electromagnet 10.

In FIGS. 1-3, as used throughout this specification, the magnetic enclosure 1 to include the closed end 1a and cylindrical pole piece 1b, armature 6, and the center pole piece 5, regardless of the shape or size, the preferably formed of soft iron, steel or some other magnetic material, with the preferred material being one which provides low reluctance, exhibits low hysteresis, and has a high magnetic flux density capability; likewise could be of laminate type construction. The permanent magnet 2 is poled north inward—south outward with the south to north direction given by the direction of the dark arrow.

FIGS. 2-3 show the two positions of the armature 6 and attached non-magnetic shaft 7. As illustrated in FIG. 2, either under power or under no power to the control coils 3 and 4, the armature 6 is magnetically latched to the coaxial poles 1b and 5 due to the force from the high force mechanism to the non-magnetic shaft 7 being less than the magnetic force plus the force from the low force mechanism on the armature 6. As illustrated in FIG. 3, either under power or under no power to the control coils 3 and 4, the armature 6 is de-latched from the coaxial poles 1b and 5, producing an air gap, as the force from the force mechanism to the non-magnetic shaft 7 is more than the magnetic force plus the force from the low force mechanism on the armature 6. In FIG. 2-3, the magnetic force on the armature 6 increases as the air gap between the armature 6 and the coaxial poles 1b and 5 deceases.

In FIG. 2 with the magnetic latching force being higher than the high force mechanism, the control coils 3 and 4 have been monetarily energized with the direction of the magnetic flux produced in the center pole piece 5 being in the direction of the armature 6, whereby the magnetic flux (arrows) follows a radial path through the toroid permanent magnet 2, bi-directionally through the center pole piece 5 with the majority of the magnetic flux (solid arrows) in one direction through the coaxial poles 1b and 5 and locking in the armature 6 with the residual magnetic flux (dash arrow) being in the other direction through coaxial poles 1b and 5 and the closed end 1a.

In FIG. 3 with the residual magnetic latching force being lower than the high force mechanism, the control coils 3 and 4 have been monetarily energized with the direction of the magnetic flux produced in the center pole piece 5 being in the direction of the closed end 1a, whereby, the magnetic flux (arrows) follows a radial path through the toroid permanent magnet 2, bi-directionally through the center pole piece 5 with the majority of the magnetic flux (solid arrows) in one direction through the coaxial poles 1b and 5 and locking in the closed end 1a with the residual magnetic flux (dash arrow) being in the other direction through coaxial poles 1b and 5, air gap and the armature 6.

In reference to FIGS. 2-3, monetarily energizing the control coils 3 and 4 in FIG. 3 with the direction of the magnetic flux produced in the center pole piece 5 being in the direction of the air gap and armature 6 with enough magnetic flux and resulting force to over the high force mechanism, the armature with the attached shaft will move toward and latch to the coaxial poles 1b and 5 per FIG. 2.

In FIGS. 2-3, as used throughout this specification,
1. The size of the motion distance (air gap) between the armature 6 and the coaxial poles 1b and 5, as shown in FIG. 3, is a function of the motion distance defined by the device producing the high force mechanism when there is no restriction of the motion distance (air gap) of the armature 6 with attached shaft 7 from the low force mechanism and the low force mechanism, which needs to be high enough to retain the shaft 7 against the high force mechanism. When the shaft 7 is attached to the high force mechanism, a low force mechanism may not be needed to retain the proper air gap.
2. The leakage magnetic flux from the various components is disregarded for simplicity, but may need to be understood in various designs using the present invention.
3. The method to firmly fix the permanent magnet 2, control coils 3 and 4, and center pole piece 5 inside the magnetic enclosure 1 can be through any means that does not take away from the functionality of the present invention. Preferably the center pole piece 5 would be firmly fixed to or an extension of the closed end 1a. An epoxy or other means can be used to fix the permanent magnet 2 and control coils 3 and 4 about the center pole piece 5.
4. The method to firmly fix the shaft 7 to the armature 6 can be through any means that does not take away from the functionality of the present invention.

As used throughout this specification, the maximum latching force attainable is a function of the permanent magnet's 2 magnetic residual flux density (Br), magnetic flux leakage in the divergent flux path electromagnetic 10, and the facing areas of the armature 6 and the coaxial poles 1b and 5.

### Control of the Coils

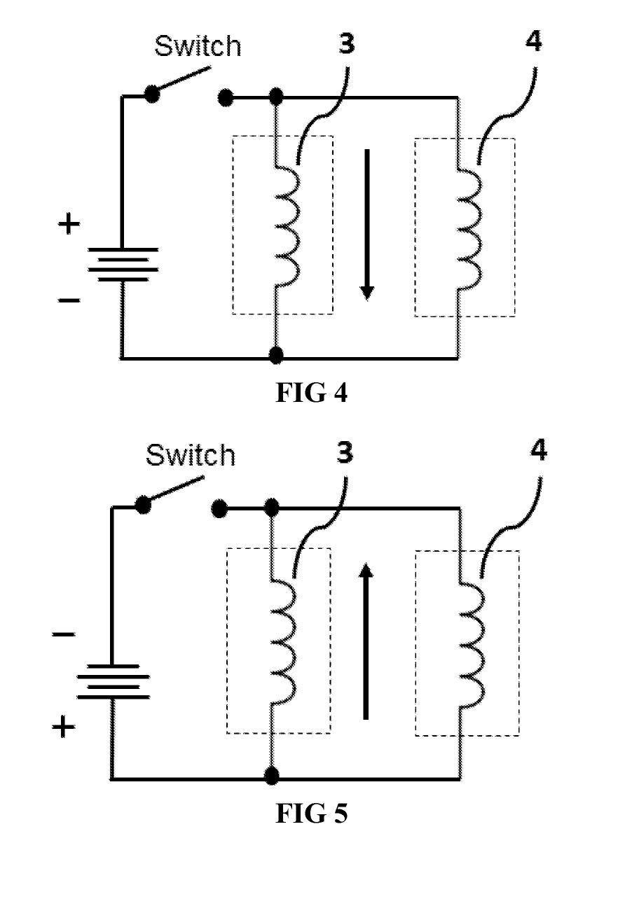

FIG. 4-5 shows the preferred parallel connection of the control coils 3 and 4, as used throughout this specification, to an alternating voltage/current source, where the arrow indicates the direction of the current through the coils when the switch is closed. It is understood that series connection can also be made, but will increase the total circuit resistance, requiring a higher voltage for a given pair of coils. In FIG. 4-5, the number of turns and the resistances of the control coils 3 and 4 are the same. The switching of the control coils voltage to reverse the current direction can be done with mechanical switches and relays or using various ICs or other methods as desired.

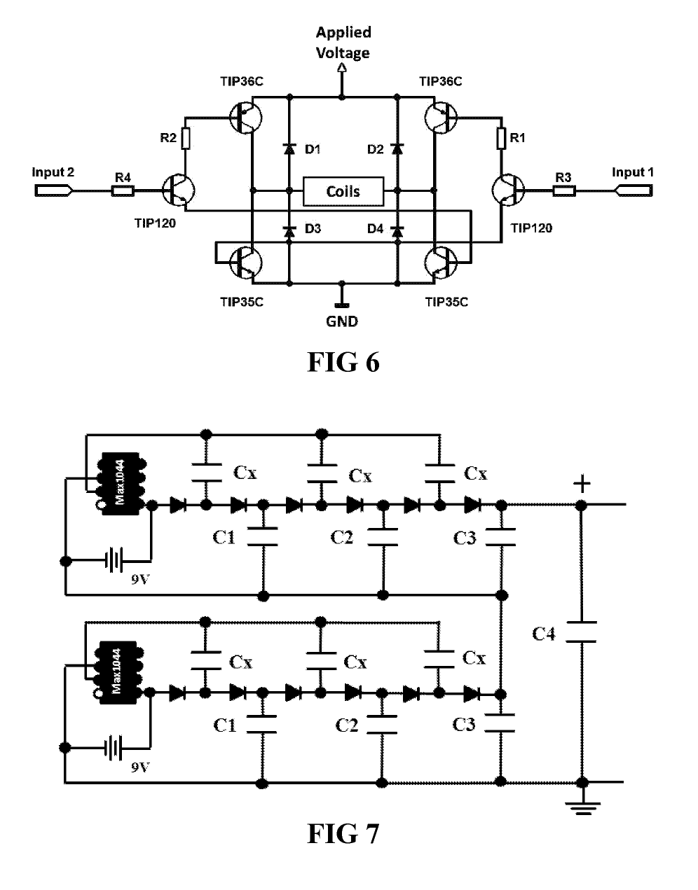

FIG. 6 shows one of many H-bridge designs, which is the preferred circuit to alternately energize the control coils pair 3 and 4 in a pulsed timed sequential manner to produce linear or bi-linear magnetic force between the armature 6 and the coaxial poles 1b and 5 to form a magnetic actuator for various applications. Connection of the control coils pairs 3 and 4 (represented by the word “Coils”) as shown in FIG. 6 allows single directionality of the magnetic flux in the center pole piece 5 by applying a voltage to either “Input 1” or “Input 2” per standard H-bridge designs, which will energize the control coil pairs 3 and 4 in like current direction.

In reference to FIGS. 2-3 and FIG. 6, when the proper voltage/current is applied to the proper input, either “Input 1” or “Input 2”, the permanent magnet-magnetic flux (solid arrows) is diverted through the center pole piece 5 as defined by the direction of the magnetic flux (solid arrows) produced by the control coil pairs 3 and 4; reversing the voltage/current directions in sequence produces the opposite effect. For a given force, wire size, and number of coil turns, the pulsing time required to unlatch or attract the armature 6 across the gap has been shown to decrease with increasing applied voltage. It has also been shown that increasing the voltage also allows for increased air gap distances. This allows for the development of divergent flux path electromagnets and magnetic actuators having variable reaction times and air gap with applied voltage.

FIG. 7 shows one of many low power capacitor charging circuits that can provide an impulse current through the H-bridge of FIG. 6 in order to reduce the energy input to the control coils pairs 3 and 4 providing for a highly energy efficient magnetic actuator. Per the MAX1044 data sheet, each voltage multiplier circuit produces 17V on capacitor “C1”, 25V on capacitor “C2” and 33V on capacitor “C3”. Series connect, as shown in FIG. 7, between two MAX1044 voltage multiplier circuits with independent 9V sources produces approximately 60V on capacitor “C4”. Increased charging voltage can be achieved by series addition of more MAX1044 voltage multiplier circuits. Although adequate, the MAX1044 voltage multiplier circuit may be slow for some applications. For faster pulse rates, direct connection of the H-bridge to the power source or another type of faster charging voltage multiplier circuits should be used.

### Energy Efficient

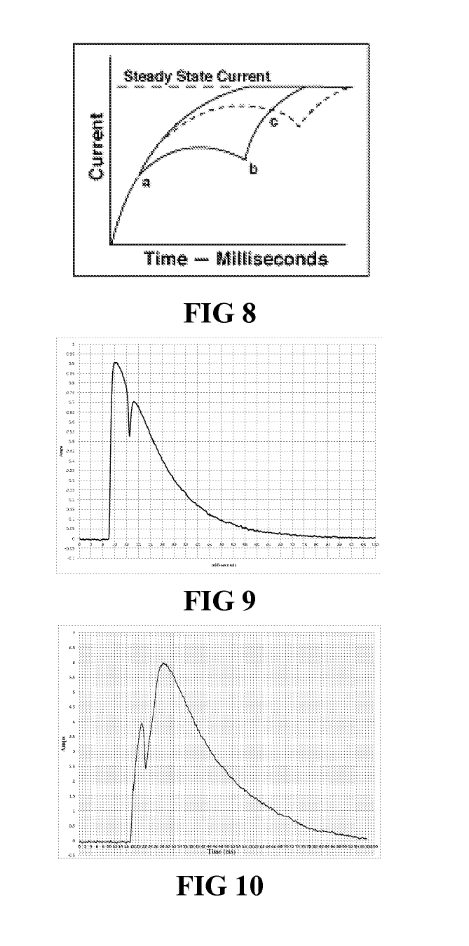

FIG. 8 illustrates the current trace for conventional magnetic actuators. When a DC voltage is impressed across the control coil, the current will rise to point (a), where the armature motion occurs as represented by the downward current to point (b), then the current moves along trace (c) to a “Steady State Current.” For a given conventional magnetic actuator, the rise time to point (a) is dependent upon the load, duty cycle, input power, stroke, and temperature range. This time delay, which occurs prior to the armature motion, is a function of the inductance and resistance of the coil, and the magnetic flux required to move the plunger.

FIGS. 9-10 are current traces from two different versions of the present invention using the same capacitor/voltage setup and the method of FIGS. 6-7, where FIG. 9 shows an ideal current trace for minimum energy usage and FIG. 10 shows that the capacitor/voltage setup was over designed for the version of the present invention used. In comparison to FIG. 8, the current traces, FIGS. 9-10, do not show a “Steady State Current” as once magnetically latched and the capacitor is discharged no more power is required. The absent of the “Steady State Current” represents a power savings over prior art. Dissipation of the energy from a capacitor then provides for a highly energy efficient replacement over the prior art of conventional electromagnets and magnetic actuators having a steady state current. The use of the over designed capacitor as shown in FIG. 10 may be required for systems with varying load, duty cycle, motion distance, input power, or temperature range.

### Length Extension

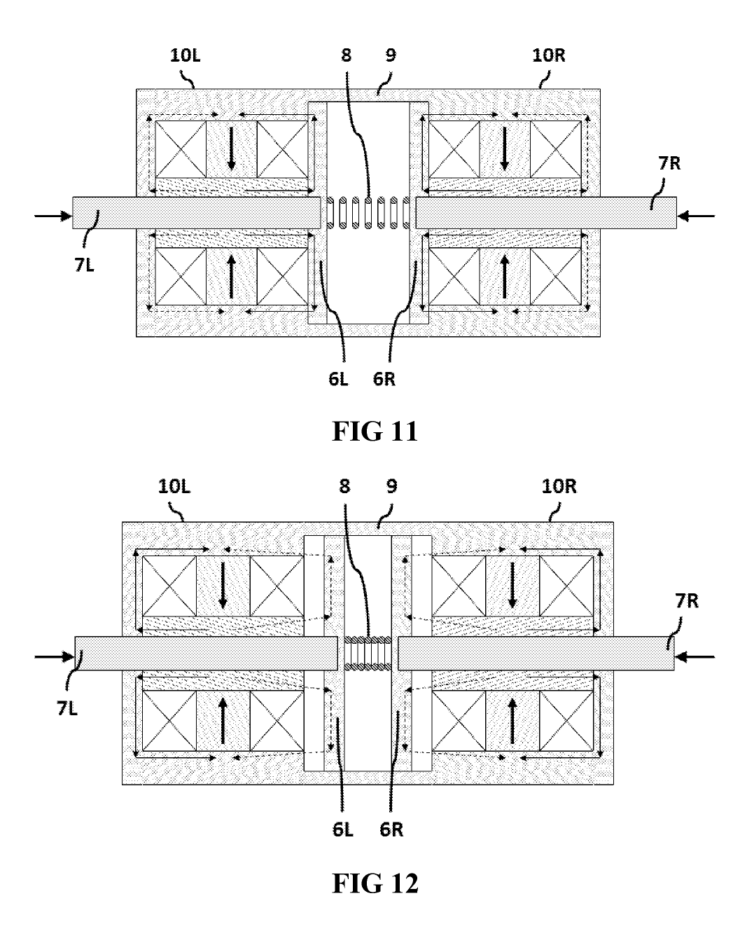

FIGS. 11-12 use two (mirrored for ease of numbering) divergent flux path electromagnet 10L and 10R of the present invention of FIGS. 2-3 to double the extension length of the non-magnetic shaft 7. FIG. 11 shows the latched position of the armature 6L and 6R and shafts 7L and 7R and FIG. 12 shows the unlatched position of the armature 6L and 6R and shafts 7L and 7R.

In FIGS. 11-12, the dark arrows indicate the force from the high force mechanism and it is understood that:
1. The divergent flux path electromagnet 10L and 10R operate as discussed for FIGS. 2-3, either independently or as one unit with independent or separate control circuitry in-like to FIGS. 6-7,
2. The spring 8 acts as the low force mechanism, and
3. The spacer 9 is a representation of one of many means to firmly attach the two divergent flux path electromagnet 10L and 10R.

### Interface Adapter

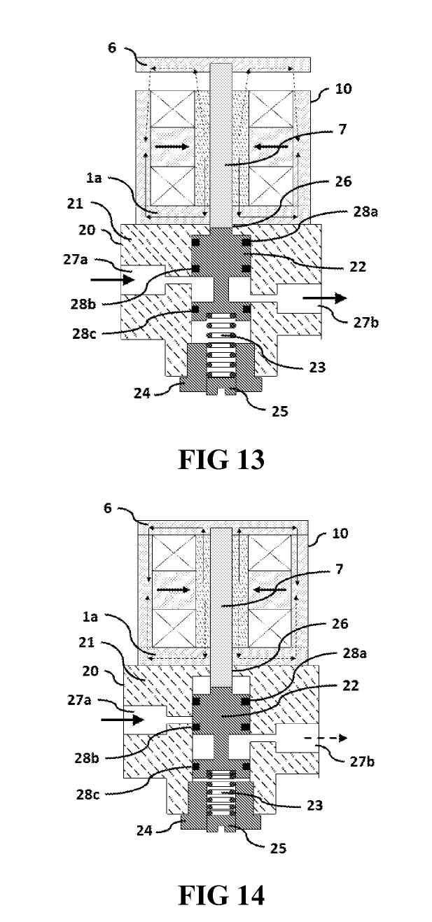

FIGS. 13-14 is presented to show how the present invention can be attached to another device using the closed end 1a of the divergent flux path electromagnet 10 as the interface adapter between the divergent flux path electromagnet 10 and the other device. Various means of adapting other devices to the divergent flux path electromagnet 10 can be used without taking away from the intended function of the present invention.

### Flow Valve

FIGS. 13-14 show a representation of one of many flow valve designs incorporating the divergent flux path magnetic actuator of FIGS. 2-3 connected to a simple valve 20, where FIG. 13 shows an open flow path (indicated by the two dark arrows) through the valve housing 21 and poppet 22 and FIG. 14 shows the poppet 22 closing the flow path (indicated by the one dark arrow and one dashed arrow, where the dash arrow representing no-flow). In FIG. 13, the poppet 22 is held in the open position by the spring 23 as the high force mechanism acting through the poppet 22 and shaft 7 to force the armature 6 away from the divergent flux path electromagnet 10. In FIG. 14, the poppet 22 is held in the closed position by the armature 6 magnetically latching to the divergent flux path electromagnet 10 acting through the poppet 22 and shaft 7 to force the spring 23 to compress.

In FIGS. 13-14, the low force mechanism is not shown for convenience and it is understood that:
1. The divergent flux path magnetic actuator is operated as discussed in FIGS. 2-3,
2. The divergent flux path electromagnet 10 is firmly attached to the valve housing 21 through the end closed end 1a, and
3. The valve 20 can be of any design where the divergent flux path magnetic actuator can be used to open or close the flow path.

In FIGS. 13-14, the valve 20 is appropriately designed with a valve housing 21 of a given material for gas or liquid flow having;
1. A poppet 22 to control the flow through the housing 21,
2. A spring 23 as the high force mechanism,
3. A closure 24 with a proper sealing method, as threads, to sealing the opening for inserting the poppet 22 and spring 23 in the valve housing 21,
4. A spring adjustment 25 to balance the force on the armature 6 through the poppet 22 and the shaft 7,
5. An opening 26 in the valve housing 21 to allow the shaft 7 to move unrestrictive and against the poppet 22,
6. Ports 27a and 27b for in and out flow as indicated by the arrows with appropriate threads for connecting with tubing or piping with which the valve assembly is intended to be used, and
7. O-rings 28a, 28b and 28c to create firm pressure/leak seals, confining the gas/liquid flow to the flow path.

What is claimed is:

1. A divergent flux path electromagnet, comprising:
Permanent magnet:
(a) Composed of a permanent magnet material, preferably with a high magnetic residual flux density (Br),
(b) Being of a shape whereby it can be radially poled or forms radial poles from its center, preferably of a ring or toroid shape,
(c) Being of single piece or segmented,
(d) Being radially poled either north inward-south outward or south inward-north outward with the north inward-south outward being the preferred poling direction, and
(e) Placed between the cylindrical outer piece of the outer can shaped pole piece and the center pole piece, preferably at the centers of the outer can shaped pole piece and the center pole piece, to form extended bi-directional and coaxial magnetic poles from the permanent magnet,
(f) Provides the magnetic latching force of the divergent flux path electromagnet.
Outer can shaped pole piece:
(a) Acting as the primary housing of the divergent flux path electromagnet,
(b) Composed of a magnetic material with the preferred material being one which provides low reluctance, exhibits low hysteresis, and has a high magnetic flux density capability,
(c) Being of single piece or segmented; likewise could be of laminate type construction,
(d) Having a cylindrical outer piece, preferably positioned-centered and adjacent around the outer pole face of the permanent magnet, forming a first perpendicular and bi-directional magnetic flux path portion, extending parallel and coaxial to the center pole piece,
(e) Having a closed end on one side forming a closed magnetic flux path portion radially from the end of the cylindrical outer piece toward the center pole piece,
(f) Magnetically attractive, so as to aid in the magnetic force applied to an external magnetic material or armature opposite the closed end,
(g) Having a thickness able to form a closed magnetic flux path from the permanent magnet with little or no leakage flux along its length, and
(h) Capable of forming a closed magnetic flux path in one direction between the center pole piece and the closed end, and in the other direction, an open magnetic flux path with the center pole piece to form the exposed coaxial poles of the divergent flux path electromagnet.
Center pole piece:
(a) Composed of a magnetic material with the preferred material being one which provides low reluctance, exhibits low hysteresis, and has a high magnetic flux density capability,
(b) Adjacent to the closed end of the outer can shaped pole piece on one end, preferably an extension of the closed end of the outer can shaped pole piece,
(c) Magnetically attractive, so as to aid in the magnetic force applied to an external magnetic material or armature opposite the closed end of the outer can shaped pole piece,
(d) Being of single piece or segmented; likewise could be of laminate type construction,
(e) Having a rod or cylindrical shape, preferably a cylindrical shape with a bore through its length, whereby little magnetic flux can exist in the bore; aiding in magnetic flux reversal,
(f) Positioned-centered and adjacent the center bore of the permanent magnet and control coils forming a second perpendicular and bi-directionally magnetic flux path portion extending parallel and coaxial to cylindrical outer piece and perpendicular to the closed end of the outer can shaped pole piece,
(g) Having a thickness able to form a closed magnetic flux path from the permanent magnet, preferably with no leakage flux along its length, and
(h) The length of the cylindrical outer piece of the outer can shaped pole piece so as to form a closed magnetic flux path in one direction between the cylindrical outer piece and the closed end of the outer can shaped pole piece, and in the other direction, an open magnetic flux path with the cylindrical outer piece to form the exposed coaxial poles of the divergent flux path electromagnet.
Pair of control coils:
(a) Compose of two magnet coils, preferably of like wire gage and # of turns,
(b) Inside the outer can shaped pole piece and positioned around the center pole piece with one magnet coil on either side of the permanent magnet,
(c) Wired together to form one solenoid like unit with same magnetic directionality when alternately energized with opposite current directions,
(d) Energized by an external control circuit,
(e) Energized in a timed sequential manner to produce a closed magnetic flux path in one direction between the permanent magnet, cylindrical outer piece and the closed end of the outer can shaped pole piece, or in the other direction, an open magnetic flux path between the center pole piece and the cylindrical outer piece, alternating repeatedly as needed, and
(f) Connected to a control circuit designed to produce bi-directional current through the two magnet coils simultaneously and with adequate amount of power to properly operate the divergent flux path electromagnet.

2. The divergent flux path electromagnet as set forth in claim 1 having reduced energy requirement over prior art.

3. The divergent flux path electromagnet as set forth in claim 1 incorporated into a magnetic latch to hold various hardware to the exposed coaxial poles.

4. The divergent flux path electromagnet as set forth in claim 1 incorporated into an actuator for various mechanical actuating applications.

5. A divergent flux path magnetic actuator to be used in a wide variety of linear, bi-linear and reciprocating applications, comprising the divergent flux path electromagnet of claim 1-2 with a bore through the center pole piece to accommodate movement of a shaft attached to an armature, where the:
Armature:
(a) Composed of a magnetic material with the preferred material being one which provides low reluctance, exhibits low hysteresis, and has a high magnetic flux density capability,
(b) Being of single piece or segmented; likewise could be of laminate type construction,
(c) Positioned adjacent to the exposed coaxial poles of the divergent flux path electromagnet,
(d) Having a diameter representative to the outer can shaped pole piece of the divergent flux path electromagnet,
(e) Having a thickness able to form a closed magnetic flux path between the exposed coaxial poles of the divergent flux path electromagnet, preferably with little or no magnetic flux leakage, and
(f) Firmly attached to a shaft, whereby the application of a high enough force to the other end of the shaft can detach the armature from the exposed coaxial poles of the divergent flux path electromagnet to provide the magnetic force attractor of the magnetic actuator.
Shaft:
(a) Being firmly attached directly to or through other means to the armature, preferably at the center and perpendicular to the armature,
(b) Extending through the center pole piece and closed end of the divergent flux path electromagnet with enough clearance to allow free movement,
(c) Extending center and parallel to the length of the divergent flux path electromagnet, preferably extending outward from the closed end of the divergent flux path electromagnet for proper utilization,
(d) Composed of a non-magnetic material to reduce magnetic flux loss in the center pole piece,
(e) Composed of a material strong enough to convey the magnetic attraction force applied by the armature to the device being acted upon and the backward force from the device to the armature,
(f) Having enough length to control the designed air gap distance between the armature and the exposed coaxial poles of the divergent flux path electromagnet,
(g) Either directly connected to or free from a device to convey the forces produce by the magnetic actuator.
Force Damping or Low Force Mechanism:
(a) Composed of some mechanism and attachment capable of damping the movement of the armature with attached shaft to control the air gap distance between the armature and the exposed coaxial poles of the divergent flux path electromagnet without hindering the free movement of the armature with attached shaft, preferably a spring or spring like mechanism, and preferably designed into a device being acted upon when the shaft is directly attached to the device.

6. The divergent flux path magnetic actuator as set forth in claim 4-5, wherein additional force mechanisms are added to aid in the amount of travel and applied force by the armature with attached shaft.

7. Two or more of the divergent flux path magnetic actuators as set forth in claims 4-6 connected in a manner to extend the motion distance.

8. The divergent flux path magnetic actuator as set forth in claims 4-7 incorporated into other devices to control various positions, conditions or operations controlled by the devices. For example, devices as:
(a) A valve or pump to control the flow or pressure of gases and fluids,
(b) A switch or relay to control electrical power,
(c) A brake to control pad pressure on a brake drum or disk, or
(d) A latch to control the open or close state of a device.
